(19) United States
(12) Patent Application Publication
(10) Pub. No.: US 2021/0207987 A1
(43) Pub. Date: Jul. 8, 2021

(54) CHEMICALLY RESISTANT SUBMERSIBLE LIQUID LEVEL MEASUREMENT DEVICE

(71) Applicant: Automation Products Group, Inc., Logan, UT (US)

(72) Inventors: Robert Dee Barson, Hyde Park, UT (US); Joseph Laethem James, Logan, UT (US)

(73) Assignee: Automation Products Group, Inc., Logan, UT (US)

(21) Appl. No.: 16/736,675

(22) Filed: Jan. 7, 2020

(51) Int. Cl. G01F 23/18; F16J 15/10

(52) U.S. Cl. CPC G01F 23/18; F16J 15/104

(57) ABSTRACT

A submersible liquid level measurement device having a protective covering that shields the transducer and associated internal components from harsh external environments while at the same time allowing the necessary sensitivities of the transducer to accomplish their intended purpose unimpaired by the protective covering. The measurement device includes a transducer having a transducer face. A cable is in electronic communication with the transducer face. A weight is coupled to the transducer. A housing surrounds a first portion of the transducer and an adapter coupled to the housing and surrounds a second portion of the transducer. The measurement device includes a first seal between the transducer face and the housing, a second seal between the housing and the adapter and a third seal between the cable and the adapter. The housing can include an opening through which the transducer face is exposed.

### BACKGROUND

Submersible pressure transducers are utilized to measure liquid levels in a variety of settings and industries. Most submersible pressure transducers on the market include a piezoresistive sensor in a submersible housing. Beyond that, there are few options and alterations. However, in some instances, these liquid level sensors must be placed in harsh environments and conditions including high acidity, high alkalinity and other corrosive liquids. These conditions cause damage to and even failure of the transducers in a relatively short period of time requiring repair or replacement. This is not only a costly outcome in terms of spare parts but also often necessitates suspension of analyses or production as the defective pieces are swapped out.

Accordingly, it would be advantageous to have a submersible pressure transducer capable of effectively measuring liquid levels while at the same time being substantially shielded from hostile external conditions that would prematurely cause instrument damage or failure. However, such a device would also need to maintain its sensitivity in detecting pressure changes, thus accomplishing its intended purpose.

The present invention in its various embodiments addresses each of these issues as well as others by providing a submersible liquid level measurement device having a protective covering that shields the transducer and associated internal components from harsh external environments while at the same time allowing the necessary sensitivities of the transducer to accomplish their intended purpose unimpaired by the protective covering.

### SUMMARY

The present invention is a submersible liquid level measurement device having a protective covering that shields the transducer and associated internal components from harsh external environments while at the same time allowing the necessary sensitivities of the transducer to accomplish their intended purpose unimpaired by the protective covering. In one embodiment, the measurement device includes a transducer having a transducer face on one end. A cable is in electronic communication with the transducer face and extends from the other end. A weight is coupled to the transducer. A housing surrounds a first portion of the transducer and an adapter coupled to the housing and surrounds a second portion of the transducer. The measurement device includes a first seal between the transducer face and the housing, a second seal between the housing and the adapter and a third seal between the cable and the adapter. The housing can include an opening through which the transducer face is exposed.

In certain embodiments, the first seal is a flat gasket seal but could be other sealing mechanisms alone or in combination such as O-rings, welds and chemical bonding. In certain embodiments, the second seal features a ring geometry built into the housing and a mating concave geometry built into the adapter. The ring geometry can include a protective sleeve to protect the seal from foreign objects. The third seal can be a concentric crimp around a sealing sleeve in the adapter. The cable can further include a jacket.

In certain embodiments, the weight features threading that corresponds to threading on the housing and the adapter. The housing can be made of various materials including, but not limited to polytetrafluoroethylene (PTFE) and fluorinated ethylene propylene (FEP) alone or in combination. Similarly, the adapter can be made of various materials including, but not limited to polytetrafluoroethylene (PTFE) and fluorinated ethylene propylene (FEP) alone or in combination. The transducer face can be made of various materials including but not limited to ceramic, crystal, polytetrafluoroethylene (PTFE), high nickel alloy, and epoxies.

In other embodiments, the sensor comprises a transducer having a transducer face; a cable in electronic communication with the transducer face; a weight coupled to the transducer; a housing enclosing a first portion of the weight; and an adapter enclosing a second portion of the weight. There is a first seal between the transducer face and the housing; a second seal between the housing and the adapter; and a third seal between the cable and the adapter.

In yet other embodiments, the sensor comprises a transducer having a transducer face; a cable in electronic communication with the transducer face; a weight coupled to the transducer; a housing enclosing a first portion of the weight; and an adapter enclosing a second portion of the weight. The adapter can include an internal space. The weight can include a protruding ring and one or more planar notches. The housing can include an annular groove that corresponds to the protruding ring on the weight. Again, there is a first seal between the transducer face and the housing; a second seal between the housing and the adapter; and a third seal between the cable and the adapter.

In certain embodiments, the annular groove on the housing and the protruding ring on the weight create a first interlocking geometry. The internal space in the adapter and the one or more planar notches on the weight create a second interlocking geometry. The first and second interlocking geometries create one or more reservoirs for a liquid encapsulent.

### BRIEF DESCRIPTION OF THE DRAWINGS

FIG. 1 is a front perspective view of a chemically resistant submersible liquid level measurement device according to one embodiment of the present invention.

FIG. 2 is a sectional view of the chemically resistant submersible liquid level measurement device of FIG. 1.

FIG. 3 is a side-sectional view of a chemically resistant submersible liquid level measurement device according to one embodiment of the present invention.

FIG. 4 is an expanded view of section A in FIG. 3.

FIG. 5 is a side-sectional view of a chemically resistant submersible liquid level measurement device according to one embodiment of the present invention.

FIG. 6 is an expanded view of section B in FIG. 5.

FIG. 7 is a side-sectional view of a chemically resistant submersible liquid level measurement device according to one embodiment of the present invention.

FIG. 8 is an expanded view of section C in FIG. 7.

FIG. 9 depicts a crimping tool according to one embodiment of the present invention.

FIG. 10 is a side-sectional view of a chemically resistant submersible liquid level measurement device according to one embodiment of the present invention.

FIG. 11 is a side-sectional view of a chemically resistant submersible liquid level measurement device according to one embodiment of the present invention.

FIG. 12 is an expanded view of sections D and E in FIG. 11.

FIG. 13 is a front perspective view of a weight according to one embodiment of the present invention.

### DESCRIPTION OF ILLUSTRATED EMBODIMENTS

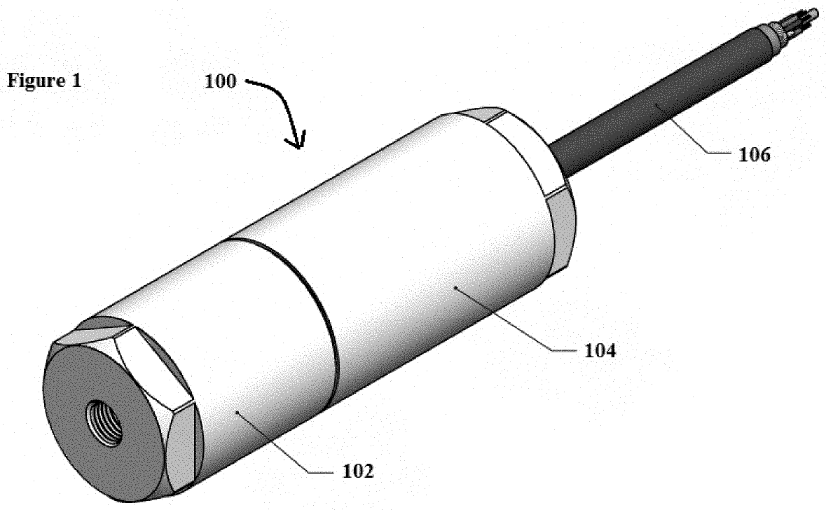

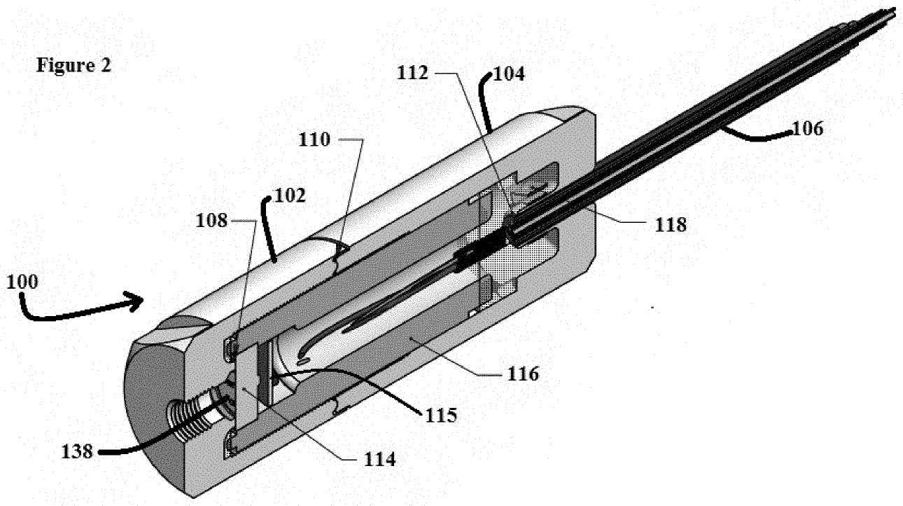

Referring to FIGS. 1-2, a chemically resistant submersible liquid level measurement device 100 is shown according to one embodiment of the present invention. As seen in FIG. 1, the liquid level measurement device 100 includes a housing 102 coupled to an adapter 104 from which a cable 106 extends. The housing 102 and adapter 104 are made of polytetrafluoroethylene (PTFE) or fluorinated ethylene propylene (FEP) alone or in combination. Thus, as described further below, the housing 102 and adapter 104 together create an enclosure into which a transducer 114 and associated electronic components such as specific output boards and electrical protection circuitry 115 (FIG. 2) may be placed. In certain embodiments, the transducer 114 is housed in a weight 116 that can not only support and protect the transducer 114 but also provides a high specific gravity specification to the measurement device 100 allowing it negative buoyancy with high density liquids to resist turbulent flows in such liquids.

The cable 106 encloses the wiring that connects the transducer 114 to a power source (not shown) and also an output that allows the sensor data to be carried to a processor (not shown), programmable logic computer (PLC), or other computing device coupled to a user interface.

As seen in FIG. 2, the liquid level measurement device 100 includes three main seals 108, 110 and 112 that allow the housing 102 and adapter 104 to create a liquid-proof protective coating around the transducer 114 and other internal components. These seals 108, 110, 112 can generally be described as: 1) a transducer 114 to housing 102 seal 108; 2) a housing 102 to adapter 104 seal 110; and 3) an adapter 104 to cable 106 seal 112.

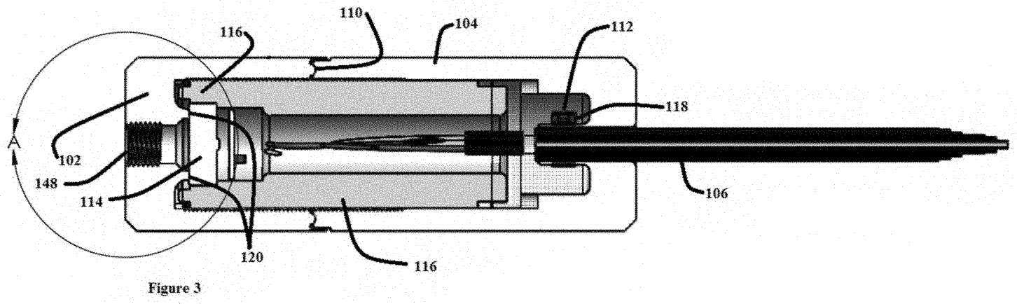

FIGS. 2-4 depict an example of a transducer 114 to housing 102 seal 108 according to one embodiment of the present invention. In this embodiment, the transducer 114 is positioned substantially near the bottom of the housing 102 with the transducer face 138 exposed to the external conditions through opening 148. It is noted that, as used herein, “bottom” or other spatial references are provided for illustrative purposes only and are not intended to limit the present invention to any particular orientation. In the present embodiment, the transducer face 138 is made of ceramic but could be made of other materials known in the art including but not limited to crystal, polytetrafluoroethylene (PTFE), high nickel alloy, and epoxies.

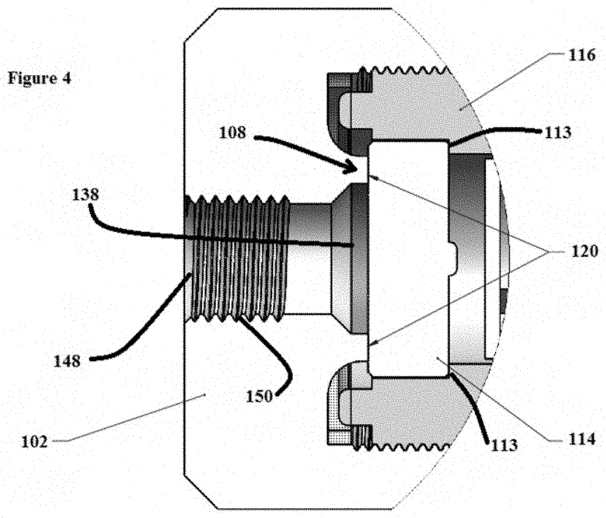

Transducer 114 in the illustrated embodiment is seated on a ledge 113 (FIG. 4) in the weight 116. This configuration allows for easier assembly and additional support for the transducer 114. However, in other embodiments, the transducer 114 could be secured to the weight 116 by other means including, but not limited to a press fit, chemical bonding, and welding. Transducer 114 also interfaces with housing 102 at 120. In the illustrated embodiment, a flat gasket or other similar sealing mechanism is built into the housing 102 at this position to create the transducer 114 to housing 102 seal 108. Axial force on the seal 108 is produced by the weight 116 being torqued into the housing 102 which presses the weight 116 into the transducer 114 along ledge 113 which in turn presses the transducer 114 into the flat gasket in the housing 102.

Typical flat gaskets suitable for use with the present invention could be made of a variety of known materials including but not limited to polytetrafluoroethylene (PTFE), fluorinated ethylene propylene (FEP), ceramic, crystal, high nickel alloy, epoxies, perfluoroelastomers such as Kalrez, available from DuPont de Nemours, Inc. (Midland, Mich.), elastomers and plastics alone or in combination.

In yet other embodiments, instead of utilizing a flat gasket, one could similarly utilize an O-ring or bonding techniques such as welding or chemical bonding. The flat gasket is typically annular and surrounds the transducer face 138 substantially corresponding with its shape. Thus, the transducer face 138 is able to interact with the liquid being measured but the flat gasket pressed between the transducer 114 and the housing 102 prevents the same liquids from leaking into the internal components of the measurement device 100 thereby compromising its operability.

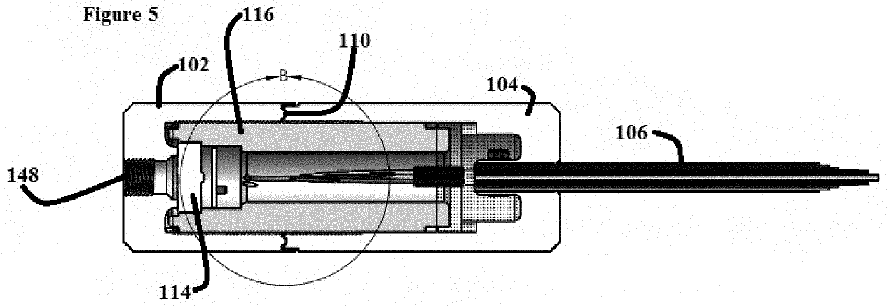

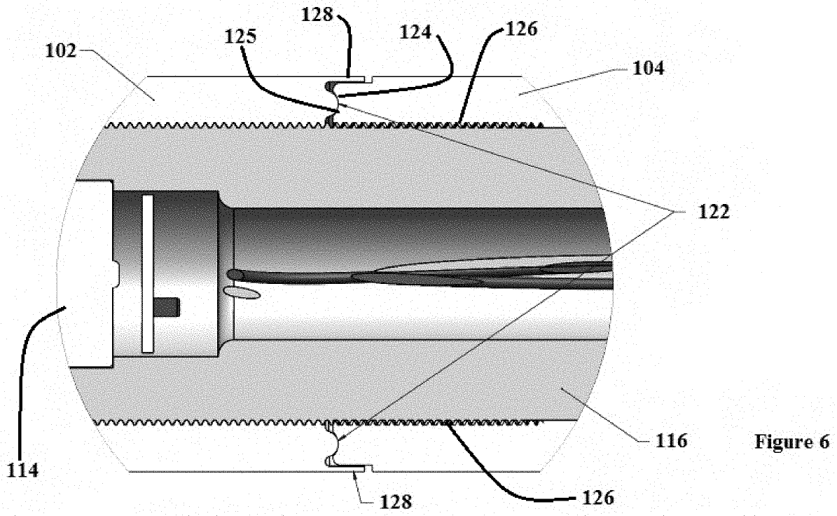

Referring now to FIGS. 5 and 6, an example of a housing 102 to adapter 104 seal 110 is shown according to one embodiment of the present invention. This seal 110 features a ring geometry 122 that is built into housing 102 that effectively acts as an O-ring seal. The ring geometry 122 includes a substantially convex surface 125 on housing 102 and a substantially concave mating surface 124 built into the adapter 104. By having the ring geometry 122 integrated into the housing, the seal 110 is much less prone to failure than would be a typical O-ring seal. It is however noted that, in certain embodiments, it may be desirable to have the convex surface on the adapter 104 and the mating concave surface on the housing 102.

FIG. 6 illustrates threads 126 on the weight 116 that engage corresponding threads in the housing 102 and adapter 104. The weight 116 thus serves as the anchor component for the housing 102 and adapter 104. An axial compression is created on the seal 110 by torqueing the housing 102 and adapter 104 together along the threaded connection. In this manner, the housing 102 and adapter 104 are sealed together such that the transducer 114 and corresponding internal components are protected from any external liquids. In the illustrated embodiment, housing 102 also can include a built-in protective sleeve 128 to protect the seal geometry 122 from foreign objects.

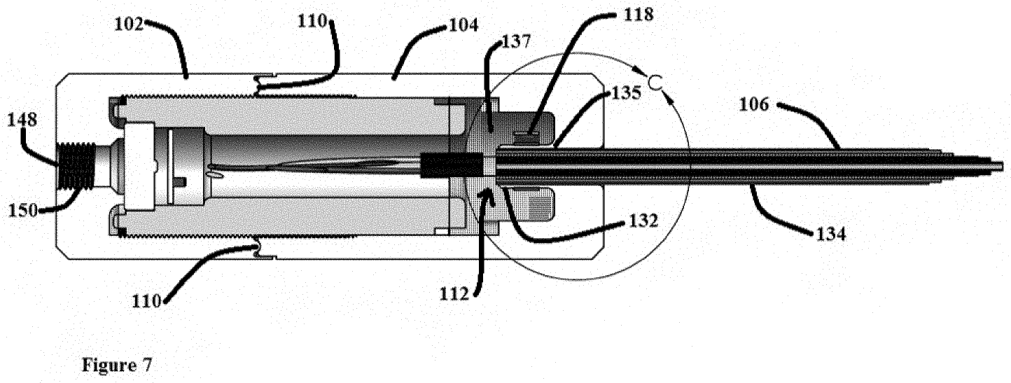

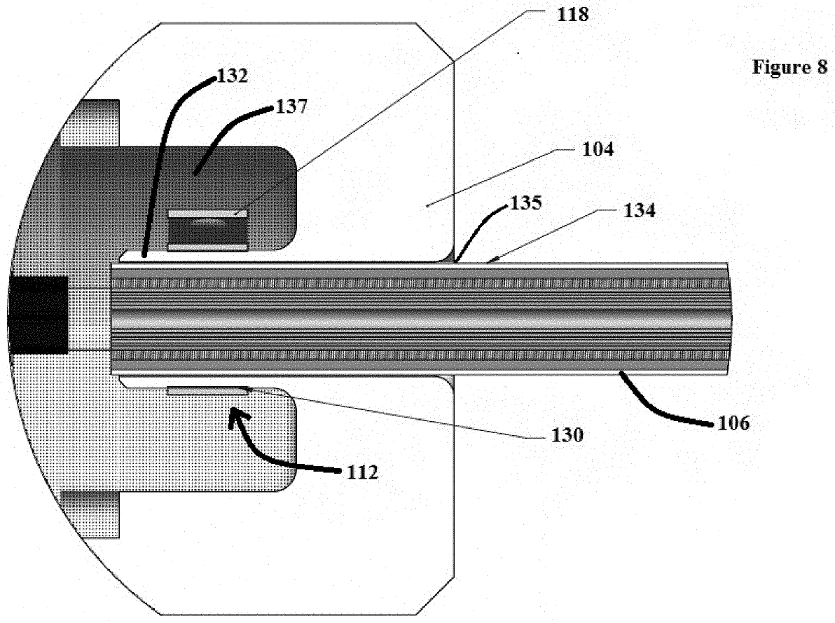

Referring now to FIGS. 7 and 8, an example of an adapter 104 to cable 106 seal 112 is shown according to one embodiment of the present invention. This seal 112 features a concentric cable crimp 118 surrounding a sealing sleeve 132 that is built into the adapter 104. A cable jacket 134 surrounds cable 106. In one embodiment, the cable jacket 134 is made of polytetrafluoroethylene (PTFE) or fluorinated ethylene propylene (FEP) alone or in combination as is the entire enclosure comprising the housing 102 and adapter 104. Thus, all wetted materials are polytetrafluoroethylene (PTFE) or fluorinated ethylene propylene (FEP) alone or in combination.

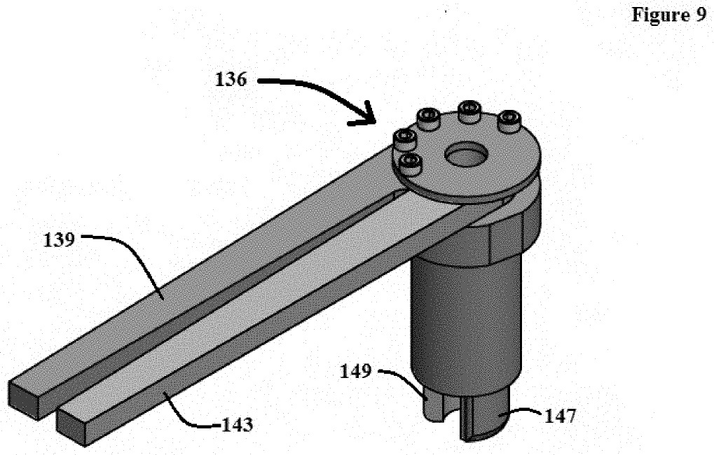

In operation, a crimping tool 136 as disclosed in FIG. 9 is inserted into space 137 during assembly and compresses the cable crimp 118 such that it presses tightly onto the sealing sleeve 132 around the entire circumference of the cable jacket 134. It is also noted that, in certain embodiments, the cable jacket 134 snugly fits into opening 135 of the adapter 104. Thus, a substantial portion of external liquids is already kept out of the internal components of the measurement device 100 simply by the friction fitting between the cable jacket 134 and the sealing sleeve 132. Including the crimp 118 makes the seal 112 effectively impenetrable to liquids.

The custom crimping tool 136 depicted in FIG. 9 can be used to create crimp 118. The tool 136 includes arms 139, 143 that corresponds to crimpers 147, 149 respectively. In operation, crimpers 147, 149 would be lowered onto deformable tabs. Pressing arms 139, 143 together causes crimpers 147, 149 to concentrically apply force to deformable tabs to create a concentric crimp 118. The deformation of the tabs decreases the inside diameter of the crimp 118 applying compression between the housing jacket 132 and cable 134.

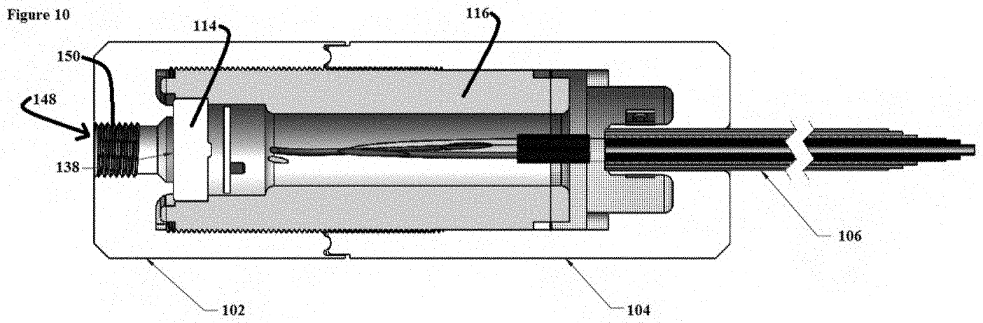

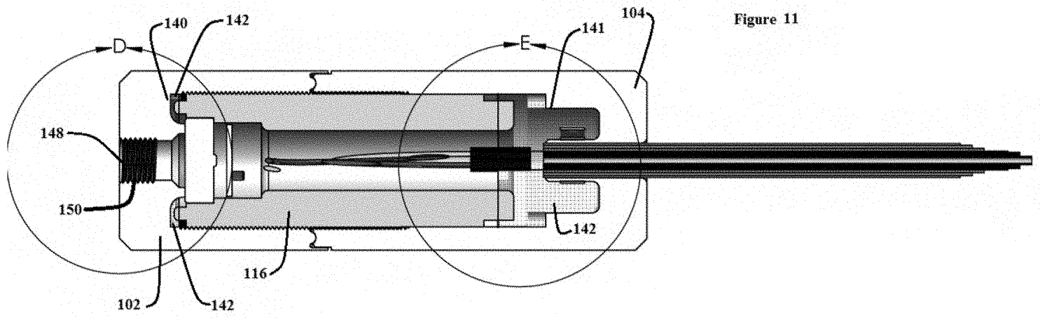

As seen in FIGS. 10-12, the housing 102 can include an opening 148 in the bottom into which external liquids can enter. In the illustrated embodiment, the opening 148 includes threading 150. This threading 150 allows for internal testing and calibration, external testing and calibration, or industrial use of the sensor in non-submersible applications. At the top of the opening 148 the transducer face 138 is exposed. As noted above, while the liquids can interact with the transducer face 138 such that desired readings can be obtained, the combination of the seals 108, 110, 112 prevent such liquids from entering into the internal components of the measurement device. The seals 108, 110, 112 in combination with the housing 102 and adapter 104 also provide a durable, highly chemically resistant protective covering allowing the measurement device to be placed in a variety of harsh conditions.

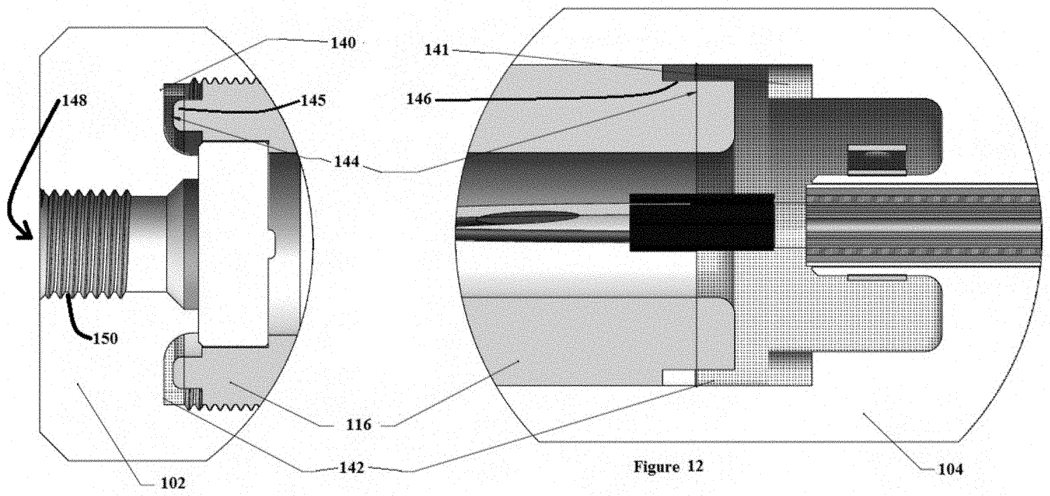

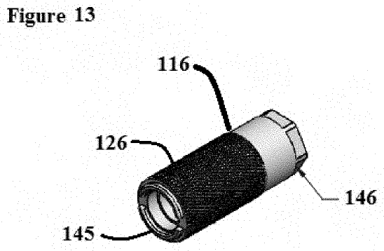

As best seen in FIG. 12, the measuring device 100 can also include specific interlocking geometry that not only helps aid in preventing liquids from contacting the internal components of the sensor 100 but also locks the measurement device 100 together after assembly to prevent tampering. In the illustrated embodiment, housing 102 includes a substantially annular groove 140 that corresponds to a protruding ring 145 on the weight 116 (FIG. 13). It is noted that, while a ring 145 and groove 140 are used in the present embodiment, in other embodiments, other suitable interlocking geometries suitable for use with the present invention include, but are not limited to serrated washers, interlocking plastic and metal and preset interlocking tabs. Similarly, adapter 104 can include interlocking geometry such as an internal space 141 that corresponds to one or more substantially planar notches 146 on the weight 116 (FIG. 13). Again, while planar notches 146 and space 141 are used in the present embodiment, in other embodiments, other suitable interlocking geometries suitable for use with the present invention include, but are not limited to serrated washers, interlocking plastic and metal and preset interlocking tabs.

In both the housing 102 and the adapter 104 the interlocking geometries create spaces that serves as reservoirs for encapsulent 142. In the illustrated embodiment, during assembly, the groove and space 140, 141 of the housing 102 and adapter 104 respectively are filled with a liquid encapsulent 142. As seen in FIG. 12, an encapsulent level mark 144 can be included to indicate the optimal volume to achieve the desired encapsulation or potting. Once the encapsulent 142 is in place, the housing 102 and adapter 104 are secured to the weight 116 along threads 126 as discussed above. Then, as can be seen in FIG. 12, once the encapsulent 142 has cured, it overlaps and interconnects the interlocking geometry of the weight 116 with the interlocking geometries of the housing 102 and adapter 104. Encapsulent 142 provides an additional barrier to the entry of external liquids into the internal components of the measuring device 100. As noted above, encapsulation also is advantageous in that it prevents instrument tampering.

FIG. 13 is an illustration of a weight 116 according to one embodiment of the present invention. This weight 116 includes a ring-shaped weight interlocking geometry 145 as discussed above and a planar weight interlocking geometry 146. Threads 126 are also depicted. As noted above, these threads 126 allow the weight 116 to engage with the housing 102 and adapter 104 to create a secure fit. As noted above, weight 116 houses and protects and secures the transducer 114 but also has a high specific gravity specification allowing it negative buoyancy with high density liquids to resist turbulent flows in such liquids.

Numerous other modifications and alternative arrangements may be devised by those skilled in the art without departing from the spirit and scope of the present invention. While the present invention has been described and illustrated in the context of the embodiments discussed above, numerous changes, modifications and substitutions of equivalents may be made without departing from the spirit and scope of this invention which is intended to be unlimited by the foregoing except as may appear in the following appended claims.

For example, in certain embodiments, the housing 102 and adapter 104 are not entirely made of polytetrafluoroethylene (PTFE) or fluorinated ethylene propylene (FEP) but rather are merely coated with a layer of PTFE or FEP alone or in combination with the remainder of the housing 102 and adapter 104 being made of other materials such as steel or nickel alloys providing a heavier pressure transducer that could be used for denser liquids.

What is claimed is:

1) A sensor comprising:
a transducer having a transducer face on a first end of the transducer;
a cable in electronic communication with the transducer face extending from a second end of the transducer;
a weight coupled to the transducer;
a housing surrounding a first portion of the transducer;
an adapter coupled to the housing and surrounding a second portion of the transducer;
a first seal between the transducer face and the housing;
a second seal between the housing and the adapter; and
a third seal between the cable and the adapter.

2) The sensor of claim 1, wherein the housing includes an opening through which the transducer face is exposed.

3) The sensor of claim 1, wherein the first seal is a flat gasket seal.

4) The sensor of claim 1, wherein the first seal is one or more sealing mechanisms selected from the group consisting of O-rings, welds and chemical bonding.

5) The sensor of claim 1, wherein the second seal further comprises a ring geometry built into the housing and a mating concave geometry built into the adapter.

6) The sensor of claim 5, wherein the ring geometry further includes a protective sleeve.

7) The sensor of claim 1 wherein the third seal is a concentric crimp around a sealing sleeve in the adapter.

8) The sensor of claim 7 wherein the cable further includes a jacket.

9) The sensor of claim 1 wherein the weight further comprises first threading that corresponds to second threading on the housing and third threading on the adapter.

10) The sensor of claim 1 wherein the housing is made of one more materials selected from the group consisting of polytetrafluoroethylene (PTFE) and fluorinated ethylene propylene (FEP).

11) The sensor of claim 1 wherein the adapter is made of one more materials selected from the group consisting of polytetrafluoroethylene (PTFE) and fluorinated ethylene propylene (FEP).

12) The sensor of claim 1 wherein the transducer face is made of one or more materials selected from the group consisting of ceramic, crystal, polytetrafluoroethylene (PTFE), high nickel alloy, and epoxies.

13) A sensor comprising:
a transducer having a transducer face;
a cable in electronic communication with the transducer face;
a weight coupled to the transducer;
a housing enclosing a first portion of the weight;
an adapter enclosing a second portion of the weight;
a first seal between the transducer face and the housing;
a second seal between the housing and the adapter; and
a third seal between the cable and the adapter.

14) The sensor of claim 13, wherein the first seal is a flat gasket seal.

15) The sensor of claim 13, wherein the second seal further comprises a ring geometry built into the housing and a mating concave geometry built into the adapter.

16) The sensor of claim 13 wherein the third seal is a concentric crimp around a sealing sleeve in the adapter.

17) A sensor comprising:
a transducer having a transducer face;
a cable in electronic communication with the transducer face;
a weight coupled to the transducer, wherein the weight includes a protruding ring and one or more planar notches;
a housing enclosing a first portion of the weight, wherein the housing includes an annular groove that corresponds to the protruding ring on the weight;
an adapter enclosing a second portion of the weight, wherein the adapter includes an internal space;
a first seal between the transducer face and the housing;
a second seal between the housing and the adapter; and
a third seal between the cable and the adapter.

18) The sensor of claim 17 wherein the annular groove on the housing and the protruding ring on the weight create a first interlocking geometry.

19) The sensor of claim 18 wherein the internal space in the adapter and the one or more planar notches on the weight create a second interlocking geometry.

20) The sensor of claim 19 wherein the first and second interlocking geometries create one or more reservoirs for a liquid encapsulent.
